(19) United States
(12) Patent Application Publication
(10) Pub. No.: US 2002/0011566 A1
(43) Pub. Date: Jan. 31, 2002

(54) Thin-film phase plate, phase-contrast electron microscope using same, and method of preventing charging of phase plate

(75) Inventors: Kuniaki Nagayama, Aichi (JP); Radostin S. Danev, Aichi (JP)

Correspondence Address: David C. Hanson, WEBB ZIESENHEIM LOGSDON ORKIN & HANSON, P.C., 700 Koppers Building, 436 Seventh Avenue, Pittsburgh, PA, 15219, US

(73) Assignee: JEOL Ltd., Tokyo (JP)

(21) Appl. No.: 09/818,239

(22) Filed: Mar. 27, 2001

(30) Foreign Application Priority Data
Mar. 27, 2000 (JP) 2000-85493

(51) Int. Cl. G21K 7/00; G01N 23/00

(52) U.S. Cl. 250/311

(57) ABSTRACT

An antistatic phase plate for use in a phase-contrast electron microscope. The phase plate is made of a thin film held on the objective aperture of the microscope for shifting the phases of incident and scattered electron waves by a uniform amount. The thin film is a conductive amorphous material typified by amorphous carbon and amorphous gold or a composite of such conductive amorphous materials. A genuinely circular, microscopic electron passage hole is formed in the center of the opening in the objective aperture. Alternatively, a genuinely circular amorphous material is deposited on the center of the opening in the objective aperture to delay the phase of electron waves by π.

### BACKGROUND OF THE INVENTION

1. Field of the Invention

The present invention relates to an electron microscope and, more particularly, to a phase plate essential for a phase-contrast electron microscope that is based on an ordinary electron microscope and designed to image phase variations occurring when electron waves are transmitted through an object to be observed. Also, the invention relates to a phase plate essential to such a phase-contrast electron microscope, a method of fabricating this phase plate, a method of examining the performance of the phase plate, and a method of manipulating and using the phase plate to make fall use of the performance.

2. Description of the Related Art

Almost every substance is transparent to electron beams and so the electron beams are only slightly absorbed by substances. Electron beams are scattered by objects and acting as electron waves, vary in phase of the waves. Generally, phase variations appear as phase delay.

Transparent substances exhibit neither absorption nor reflection with respect to incident waves. Therefore, neither photographs nor microscope images are obtained. However, in the field of light, methods for imaging phases in transparent substances have been devised for nearly 70 years using a Schlieren camera or phase-contrast microscope. In any of these methods, phase variations of incident waves caused by a substance are converted into intensity variations of the incident waves and imaged. In recent years, methods of converting phase information into diffraction patterns, such as holography, have been used. In any method, phase information is converted into intensity information by making use of the interference between phase-varied, scattered waves and phase-fixed, reference waves.

In the case of microscopes using electron beams, methods of converting phase contrast into intensity variations have been devised for many years, because objects to be observed are mostly transparent. Today, bright-field electron microscopy that was proposed by Scherzer 50 years ago and introduces defocus is still adopted in general (O. Scherzer, Journal of Applied Physics 20 (1949) 20-29). This utilizes the well-known phenomenon that when a transparent body is imaged using a lens, if the image is intentionally defocused, it appears as a high-intensity image. In particular, interference between incident waves and waves scattered by the transparent body is modulated by a function that depends sinusoidally on the amount of defocus.

The characteristics of an imaging technique using the above-described interference between incident and scattered waves are expressed in terms of a transfer function of the imaging lens system. A transfer function having sinusoidal dependence as mentioned above is referred to as phase contrast transfer function sin (γ(k)), which modulates the image. More specifically, the Fourier transform of the image is multiplied by this function. One specific example of this phase-contrast transfer function (phase (CTF)) is given by

sin (γ(k)), γ(k)=ak²+bk⁴ (1)

The first term, or ak², of the right side indicates defocus, while the second term, or bk⁴, indicates spherical aberration. In the above equation, k is a wave number vector and corresponds to a spatial frequency. γ(k) indicates the effects of an additional phase shift of scattered waves produced by the use of a lens. Where a and b are 0, the focusing system is free of aberration. Also, the image is exactly in focus. That is, γ(k)=0, or sin γ(k)=0. The intensity of the image is 0. In other words, the transparent body is invisible. However, if a and b are nonzero, and if k≠0, it follows that sin γ(k)≠0. Thus, the image intensity is restored. This is the contrast-creating mechanism of the presently used electron microscope.

FIG. 6 is a diagram showing the contrast transfer function (CTF) of an electron lens system. Phase shift γ(k) introduced by an electron lens was calculated, using accelerating voltage=300 kV, spherical aberration coefficient=3 mm, and defocus=0. Curve 1 of FIG. 6 indicates a normal contrast transfer function. It indicates a contrast transfer function when a π/2-phase plate having a center hole is inserted.

FIG. 7 is a diagram illustrating the effects of charging on contrast transfer functions (CTFs) when a phase plate is inserted. (a) shows a normal CTF, i.e., no phase plate is inserted. (b) shows an anomalous contrast transfer function, i.e., a case in which a phase plate consisting of an amorphous thin film that is easily charged is inserted.

The contrast transfer function sin (γ(k)) is sinusoidal in nature and, therefore, its value is 0 when k=0 as indicated by 1 of FIG. 6. This means that image information (that is information for roughly determining the shape of the object of interest) about portions having low spatial frequencies is missing from the image. Furthermore, spatial frequency components of the image are modulated by sin (γ(k)) This presents a great problem in reproducing the image correctly. This is described below.

To better understand the phase contrast transfer function indicated by 1 of FIG. 6, a Fourier-transformed, electron microscope image of an amorphous carbon film having a uniform thickness is shown in FIG. 7(a). Since the amorphous film has no organized structure, a wholly disorderly image is taken. Its Fourier transform should be an image of bell-shaped intensity that is symmetrical about its center. However, a pattern of coaxial fringes is seen on FIG. 7(a). This fringe pattern indicating intensity that varies radially corresponds to the phase contrast transfer function indicated by 1 of FIG. 6. As a feature of a sin function, it starts at 0 around the center (k=0), and black and white alternate with each other. This modulation is applied to the Fourier-transformed image. This means that different spatial frequency components are imaged with different weights, thus distorting the image greatly. Especially, information about the shape is lost.

We now discuss a case in which the dependence on γ(k) changes from a sinusoidal function, or sin (γ(k)), to a cosine function, or cos (γ(k)). This intensity contrast transfer function indicated by curve 2 of FIG. 6 takes the form

cos (γ(k)),γ(k)=ak²+bk⁴ (2)

The first term, or ak² , of the right side indicates defocus, while the second term, or bk⁴, indicates spherical aberration. As can be seen from 2 of FIG. 6, this contrast transfer function starts at cos (γ0))=1 and is kept at 1 for some time, which is a desirable nature. If the microscope image is modulated by this contrast transfer function, image distortion would be small. Especially, low-frequency components that determine the shape are reproduced correctly. This excellent property is retained.

A phase-contrast microscope provides a good method of changing sinusoidal modulation sin (γ(k)) to cosine modulation cos (γ(k)) and reproduces the image with no distortion without setting the image intensity to 0 even if the object induces only phase variations. Accordingly, in the field of electron microscopy, phase-contrast electron microscopes have been sought for more than 40 years (1. K. Kanaya, H. Kawakatsu, “Experiment on the Electron Phase Microscope”, Journal of Applied Physics 29 (1958), pp. 1046-1051; 2. J. Faget, M. Fagot, J. Ferre, C. Fert, “Microscopie électronique à contraste de phase”, in Fifth International Congress for Electron Microscopy, Academic Press, New York, 1 (1962) A-7; 3. C. Hall, “Introduction to Electron Microscopy”, McGraw-Hill, New York, (1966) 265-267; 4. T. Thon, in Electron microscopy in material science, Academic Press, New York, (1971) 603-613; 5. D. Parsons, H. Johson, “Possibility of a Phase Contrast Electron Microscope”, Applied Optics 11 (1972) 2840-2843; 6. D. Willasch, “High Resolution Electron Microscopy with Profiled Phase Plates”, Optik 44 (1975) 17-36). All of them have demonstrated that the phase-contrast method produces higher contrast than ordinary electron microscopy (bright-field microscopy). This excellent principle that dates back to Zemike's phase-contrast light microscope (1935) has not been put into practical use, principally because it has not been possible to introduce the phase-contrast method without disturbing the focusing of the lens system. This is described in farther detail below.

The key component of a phase-contrast microscope is a phase plate placed near the back focal plane of the objective lens, the back focal plane being behind this objective lens. The role of this phase plate is to shift the phase of scattered waves by π/2 and to shift the phase of incident waves (zeroth-order diffracted light) by 0 or π. In this way, the incident and scattered waves are shifted in phase by π/2 with respect to each other and interfere. Therefore, the CTF is converted from a sinusoidal function sin (γ(k)) to a cosine function cos (γ(k)). The phase plate itself is relatively easy to fabricate using an amorphous uniform film of appropriate thickness. Its phase variation (φ) shows a simple dependence on the internal potential (V) of the material as given by Eq. (3)

$$φ = - \frac{π h}{λ} \cdot \frac{V}{{U}_{0}} \cdot \frac{1 + 2 α {U}_{0}}{1 + α {U}_{0}} , α = 0.9785 \times {10}^{- 6} {V}^{- 1} \qquad ( 3 )$$

where h is the thickness of the thin film, U₀ is the used accelerating voltage, and λ is the wavelength of electrons at this voltage. The voltage is expressed in volts. The potential V is a value intrinsic to the material if it is a neutral substance. If the accelerating voltage U₀ is given, the wavelength λ is also determined. Therefore, the amount of phase shift is in proportion to the film thickness h. For example, where acceleration is made at 300 kV, a phase shift of about π/2 occurs with a carbon film at a thickness of 30 nm. In any of the above-cited references, such an amorphous thin film producing a phase shift action is used as a phase plate.

However, where the phase plate consisting of a thin film enters the optical axis along which an electron beam passes, the phase plate becomes charged, creating a potential. This potential is added to the internal potential. In consequence, various problems take place. That is, the greatest obstacle to commercialization of a phase-contrast electron microscope does not lie in fabrication of the phase plate itself but in a potential arising from charge created on the phase plate by an electron beam and in a resulting anomalous contrast transfer function (anomalous CTF). Anomalous contrast functions often have indefinite shapes and much poorer symmetry compared with contrast transfer functions such as sin (γ(k)) and cos (γ(k)) originating from lenses. Generally, it is difficult to control anomalous contrast functions. A specific example is shown in FIG. 7(b). Where an electron-transmitting substance is inadvertently inserted in a path of an electron beam, a contrast transfer function entirely different from the contrast transfer function of FIG. 7(a) occurs. That is, phase modulation takes place. This is due to the combined effects of the nonuniformity of the optical thickness of the phase plate and the charging. Since the potential varies depending on location, the potential V varies. The additional phase shift according to Eq. (3) is added according to location. For this reason, in phase-contrast electron microscopy, images are more often greatly distorted than in normal electron microscopy. To remove this drawback, it has been necessary to make uniform the optical thickness of the phase plate and to find a method of preventing charging. Furthermore, a contrivance is required to minimize the effects of charging if it occurs.

In addition to the above-described phase plate made of a thin plate, phase plates using electrostatic fields have been proposed (7. H. Badde, L. Reimer, “Der Einfluβ einer streuen den Phasenplatte auf das elektronenmikroskopische Bild”, A. Naturforsch. 25a(1970)760-765; 8. W. Krakow, B. Siegel, “Phase Contrast in Electron Microscope Images with an Electrostatic Phase Plate”, Optik 42(1975)245-268.; 9. T. Matsumoto, A. Tonomura, “The phase constancy of electron waves traveling through Boersch's electrostatic phase plate”, Ultramicroscopy 63(1996)5-10). Also, a phase shift method using gold-coated thin wires (10. P. Unwin, “Phase contrast and interference microscopy with the electron microscope”, Philosophical Transactions of the Royal Society of London, Ser. B. 261(1971)95-104.) has been proposed. However, these suffer from the charging problems in the same way as the techniques described above.

### SUMMARY OF THE INVENTION

It is an object of the present invention to provide a practical phase-contrast electron microscope that is made of a thin film, suppresses charging, can minimize the effects of charging if it occurs, provides greatly improved contrast of electron microscope images, and can remove distortions from images.

This object is achieved by a phase plate in the form of a thin film for use in a phase-contrast electron microscope. The phase plate is placed on a path of electrons having passed through an objective lens of an electron microscope. This phase plate is characterized in that it is made of a thin film of an electric conductive amorphous material or thin film of a composite of such electric conductive amorphous materials. A microscopic electron passage hole assuming a genuinely circular form and having a diameter of 0.05 μm to 5 μm is formed in the thin film. Alternatively, a genuinely circular amorphous material having a diameter of 0.05 μm to 5 μm is deposited on the thin film for delaying phase of electron waves by π.

The present invention also provides a phase-contrast electron microscope having a phase plate. The phase plate is made of a thin film. The thin film forming the phase plate consists of an electric conductive amorphous material or a composite of electric conductive amorphous materials. The phase plate is placed on a path of electrons having passed through an objective lens of an electron microscope. A microscopic electron passage hole assuming a genuinely circular form and having a diameter of 0.05 μm to 5 μm is formed in the thin film. Alternatively, a genuinely circular electric conductive amorphous material having a diameter of 0.05 μm to 5 μm is deposited on the thin film for delaying phase of electron waves passed through a center of an electron path by π. The phase plate is placed in the back focal plane of the objective lens or behind it. Ideally, the center hole or the deposited material has an infinitely small diameter. Because it is difficult to align the electron beam, and for the sake of convenience of off-plane experiments (described later), the center hole or the deposited material has a finite size. Generally, where the accelerating voltage is set to a higher value (e.g., 400 kV), the hole is small (e.g., 0.5 μm). Where the accelerating voltage is set to a lower value (e.g., 100 kV), the hole is large (e.g., 2 μm).

The present invention provides a method of preventing charging of a phase plate placed in a path of electrons having passed through an objective lens of an electron microscope. The phase plate is made of a thin film. The thin film forming the phase plate consists of an electric conductive amorphous material or a composite of electric conductive amorphous materials. This method is characterized in that the phase plate is illuminated with a large electron dose before use of the microscope. If necessary, the phase plate is kept at a high temperature.

Other objects and features of the invention will appear in the course of the description thereof, which follows.

### BRIEF DESCRIPTION OF THE DRAWINGS

FIGS. 1(a) and 1(b) are diagrams showing a phase plate for use in a phase-contrast electron microscope, the phase plate being built in accordance with one embodiment of the present invention;

FIGS. 2(a) and 2(b) are diagrams illustrating the arrangement of a thin-film phase plate having a center hole;

FIGS. 3(a), 3(a′), 3(a″) and 3(b) show electron microscope images of amorphous carbon film placed on an object plane, the images being taken by the off-plane method;

FIGS. 4(a), 4(a′), 4(b) and 4(b′) show phase-contrast electron microscope images;

FIGS. 5(a) and 5(b) show complex electron microscope images;

FIG. 6 is a graph illustrating a contrast transfer function (CTF) of an electron lens system;

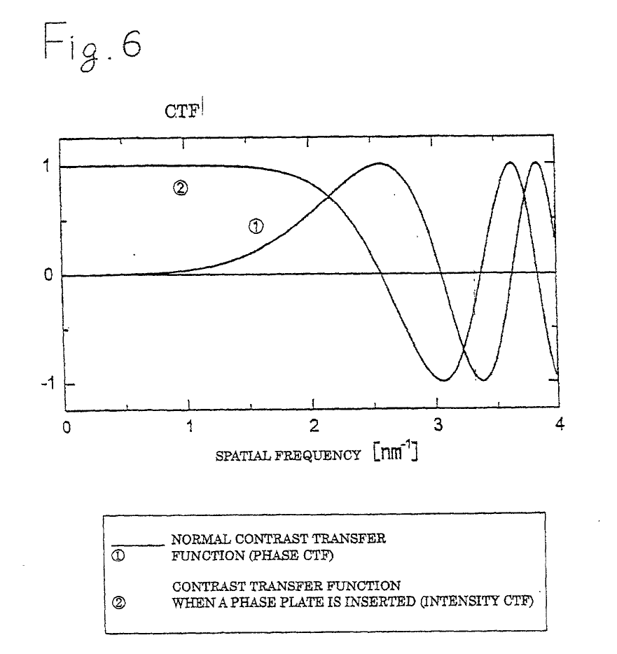

FIGS. 7(a) and 7(b) show electron microscope images illustrating the effects of charging on the contrast transfer function (CTF) when a phase plate is inserted; and

FIG. 8 is a graph showing charging curves of various phase plates.

### DESCRIPTION OF THE PREFERRED EMBODIMENTS

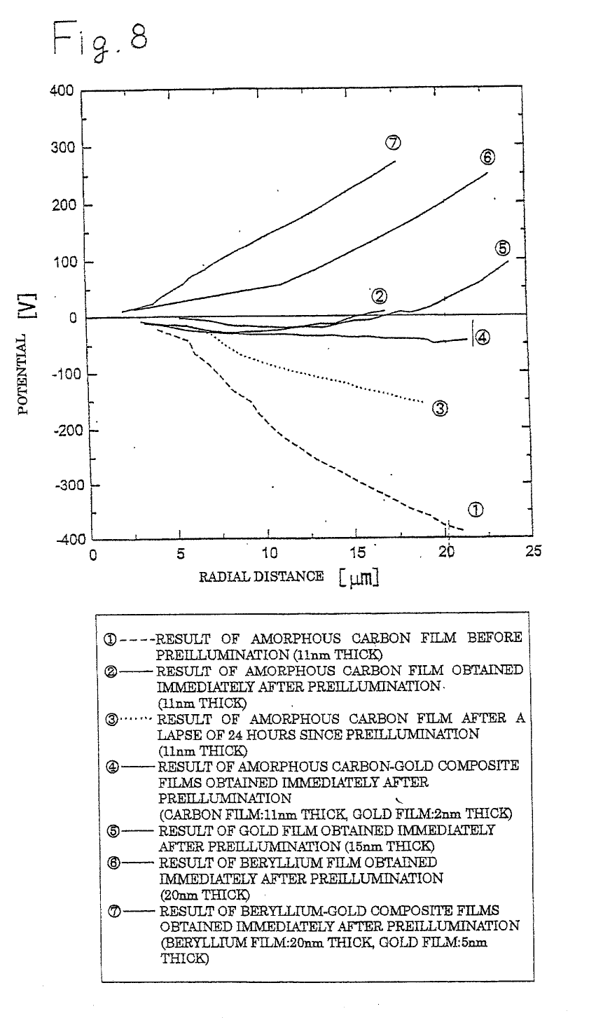

Experiments and analysis for grasping the technical essence of the present invention are first described. FIG. 8 is a diagram showing charging curves of various phase plates. The potential on each phase plate is given as a function of the distance from the center of the phase plate. The potential is found from the difference between anomalous CTF and normal CTF using Eq. (1) above.

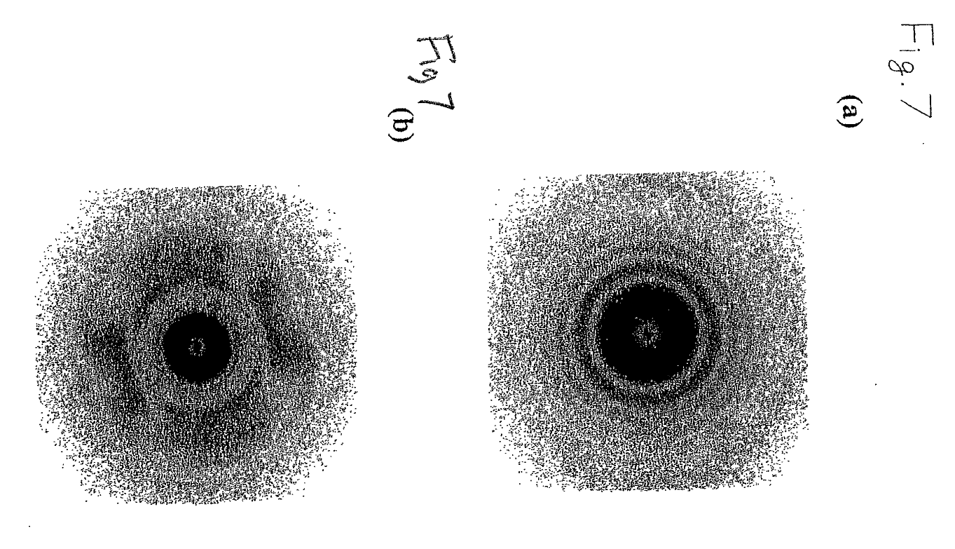

Comparison of the electron microscope image of FIG. 7(a) with the electron microscope image of FIG. 7(b) clearly reveals the effects of charging. In other words, these experiments provide a means for quantitatively measuring from the anomalous CTF image the extent to which each phase plate is charged. If the image of FIG. 7(a) is coincident with the image of FIG. 7(b), then the phase plate is not charged. The phases of electron waves are shifted by a uniform amount. The phase plate operates normally.

To analyze the charging effects, normal CTF and anomalous CTF are first compared. The difference is expressed as the dependence of anomalous shift Δγ(k) of phase on k. Then, anomalous shift of phase is converted using Eq. (3) into a potential variation owing to charging. This potential originates from charging and is added to the internal potential of the material. Subsequently, the relation between the value of k and the radial distance (r) on the phase plate is found. In this way, the actual location-dependence of the potential variations on the phase plate can be estimated. This method was applied to amorphous thin films of various materials. The results are summarized in the charging curves of FIG. 8. These experiments are intended to examine the charging characteristics of the amorphous thin films themselves. Therefore, the film thickness is not adjusted for π/2 phase shift. Also, the center hole is not formed.

Two great phenomena can be observed. First, immediately after insertion, each phase plate shows great variations between where it is preilluminated with an electron beam and where it is not. This can be seen by comparing the variation occurring before the preillumination of the electron beam (1000 electrons/Å² for 30 minutes) and the variation occurring after the preillumination. It seems that the greatest cause of this variation is evaporation of adhering contaminants within the air due to the electron-beam etching. The adhering contaminants are mostly oily nonconductive substances and tend to be electrostatically charged negatively. That the value varies with time indicates that it is necessary to remove the contaminants by the electron beam itself. After this decontamination, the phase plate will slowly become contaminated within the microscope. It is certain that the amount of negative charge on the phase plate after a lapse of 24 hours since preillumination as described in curve 3 of FIG. 8 is greater than the amount obtained immediately after the preillumination as described in curve 2 of FIG. 8.

It can be observed that the amount of charge on the phase plate is not always reduced down to zero even if a sufficient amount of preillumination is done. This is proved by charging curves indicating the results of experiments using amorphous carbon film, gold film, beryllium film, and their composite films. The beryllium film shows large positive charge as described in curve 6 of FIG. 8. On the other hand, the carbon film shows small negative charge as described in curve 2 of FIG. 8. The gold film shows small positive charge as described in curve 5 of FIG. 8. It can be seen that the charging characteristic of each composite film is not always a simple sum of the charging characteristics of its constituting materials. It seems that this is due to dynamic charging caused by such a phenomenon that electrons are captured by the phase plate. The electron capture is permitted only when a subtle balance exists between positive holes due to secondary electrons and direct electron capture during an electron reflection process. Any theoretical forecast is not yet quantitatively made. Accordingly, we consider that only one conceivable method consists of performing many experiments of this kind and searching for a material with less dynamic charging by trial and error.

Carbon and gold showed similar small dynamic charging characteristics as described in curves 2 and 5 of FIG. 8. Gold shows large electron scattering and exhibits a large loss in intensity. Therefore, it can be said that carbon which is a light element is the optimum material for a phase plate. We have accumulated experience of treating carbon. It is easy to control the thickness, the uniformity, and the impurities. Static charging characteristics are associated with the conductivity of the material. Among various carbon films, hydrocarbon films fabricated by plasma polymerization showed quite large anomalous CTFs because they are poor conductors. Therefore, impurities of hydrocarbons must be avoided in fabricating amorphous carbon films. In conclusion, a high-purity amorphous carbon film having uniform film thickness is best suited for the phase plate.

Remaining slight dependence of the dynamic charging characteristics on location is next discussed. The charging curves of the carbon and gold amorphous films shown in FIG. 8 are characterized in that they vary like quadratic curves with increasing the radial distance r corresponding to k. These charging curves reflect the dynamic charging characteristics. However, the amount of charge is considered to be the overall results of various processes including a reflected electron process, a secondary electron process, and a capture of surrounding stray electrons and, consequently, is very complex. Eq. (3) that holds under neutral conditions for a charged thin film cannot be applied. The relation between the amount of charge and the amount of phase shift is not strictly found. Accordingly, in the present situation, we are urged to search for optimum materials by experiments.

Means for solving the problems are described. The present invention is intended to solve the foregoing problems. An amorphous carbon of high purity is adopted as a material that is not readily charged. A thin film of uniform thickness is fabricated by evaporation or sputtering and held on an objective aperture. A small hole is formed as a genuine circle in the center of the opening of the objective aperture without destroying the symmetry with respect to the center.

If the phase plate fabricated in this way and to be for use in a phase-contrast electron microscope is directly inserted into the electron microscope, it would be impossible to use the phase plate at first because of severe electrification. That is, various impurities adsorbed in the air are electrostatically charged by an electron beam. To remove them, it is necessary to preilluminate the phase plate for 10 to 30 minutes with an observational electron beam of 10 to 100 times intensity. The phase plate that is antistatically treated in this way is used in a phase-contrast electron microscope. Yet, as mentioned previously, a part of the electron beam flows into the phase plate, creating dynamic charging. A contrivance is required to remove it. Eventually, an amorphous film material is selected and the electron beam is made to hit the phase plate in such a way that the amount of dynamic charging is zero. If the dynamic charging is left, its effects are utilized skillfully. The antistatic effect can also be maintained effectively for a long time by holding the objective aperture at a high temperature.

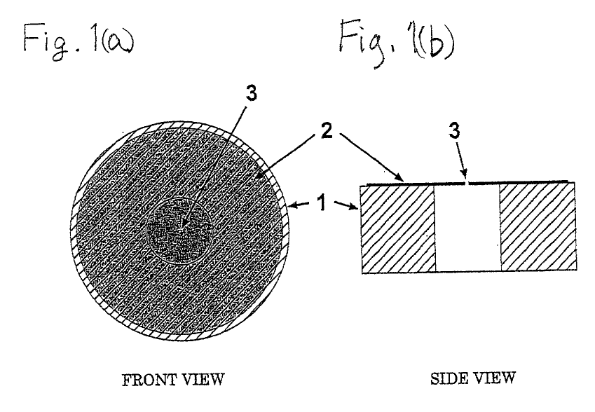

A method of fabricating the phase plate in the form of a thin film is next described. FIG. 1 shows one example of a phase plate in accordance with the present invention, the phase plate being for use in a phase-contrast electron microscope. There are shown an objective aperture 1, an amorphous thin film 2 coated over the aperture 1, and a center hole 3 formed in the aperture 1.

As shown in FIG. 1, the phase plate for use in a phase-contrast electron microscope is the amorphous thin film 2 stretched over the top surface or bottom surface of the objective aperture 1. The film 2 is centrally provided with the microscopic hole 3. The size of the hole 3 is set to 0.05 μm to 5 μm, depending on the purpose. A material that is least likely to be electrified is selected as the amorphous thin film 2. To prevent static electrification, it is necessary to use the electric conductive amorphous film 2. To prevent dynamic electrification, electron impact characteristics intrinsic in the material must be taken into consideration. An amorphous film 2 made of a material that satisfies these two conditions, e.g., carbon, is fabricated by vacuum evaporation, sputtering, or other method. The film is required to be fabricated with care so that uniformity in thickness and amorphous nature is maintained high.

To form the center hole 3 shown in FIG. 1, a genuine circle is formed in the center of the aperture 1. For this purpose, a machine for producing a focused ion beam is used. In this method, it is easy to form the hole of 0.05 μm to 5 μm. Instead of forming the center hole 3, a genuinely circular deposit of 0.05 μm to 5 μm may be placed in the center, and the zeroth-order light may be shifted by π to form a phase plate.

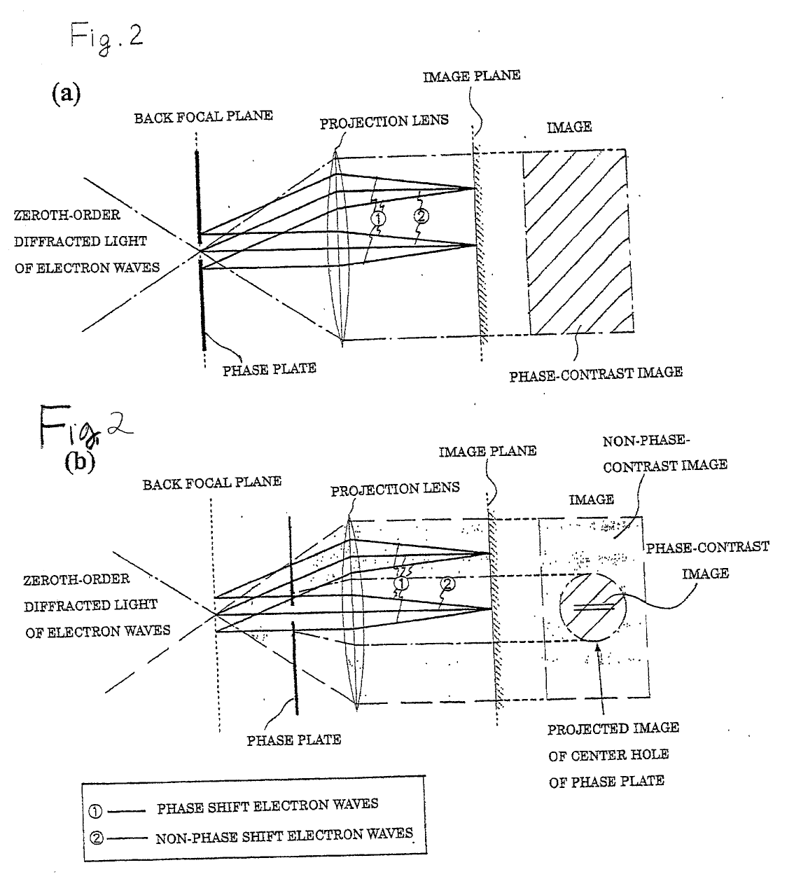

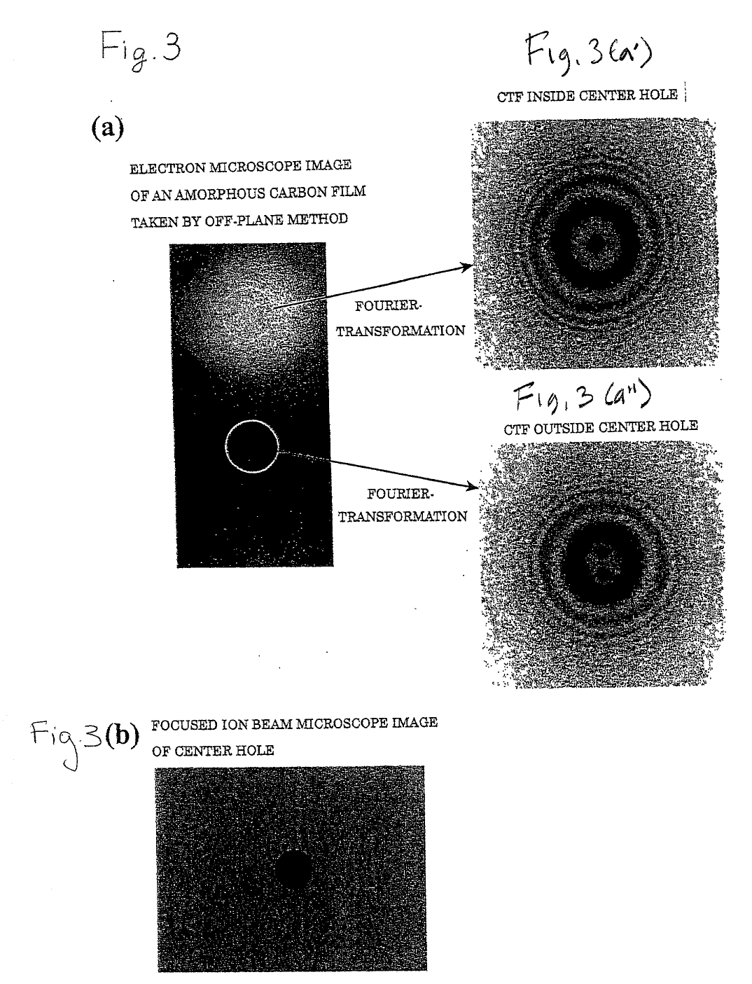

A method of manipulating and using the phase plate made of a thin film is next described. FIGS. 2(a) and 2(b) are diagrams illustrating a method of placing the thin-film phase plate having a center hole. FIG. 2(a) illustrates an in-plane method in which the phase plate is placed exactly in the back focal plane of the lens. FIG. 2(b) illustrates an off-plane method in which the phase plate is placed behind the back focal plane of the lens. FIG. 3 shows electron microscope images of amorphous carbon films placed on the object plane, the images being taken by the off-plane method. The phase plate is an amorphous carbon thin film of 24 nm. The phase shift is about 0.4 π. FIG. 2(a) shows an electron microscope image of an amorphous carbon film in which a projection of the center hole of the phase plate appears. Also, images of two contrast transfer functions of inside and outside, respectively, of the hole are shown. FIG. 2(b) shows a focused ion beam microscope image showing the roundness of the center hole.

Two different methods are available as shown in FIGS. 2(a) and 2(b), depending on how the thin-film phase plate having the center hole is placed relative to the back focal plane of the objective lens. In one method, the phase plate is placed in the back focal plane, and the zeroth-order diffracted light is fully passed through the center hole. This is the in-plane method (FIG. 2(a)). In the other method, the phase plate is placed behind the back focal plane, and a projected image of the center hole is created in the object plane. This is the off-plane method (FIG. 2(b)). In the off-plane method, the zeroth-order light crosses the phase plate at a different radius according to the distance between the phase plate and the back focal plane. In the in-plane method, the charging problem with the phase plate is alleviated. In the off-plane method, charging presents serious problems. Especially, the phase plate needs to be fabricated with various cares as mentioned previously.

The manner in which the phase-contrast image appears in the image plane can be seen by comparing the image characteristics of the in-plane method (FIG. 2(a)) and the image characteristics of the off-plane method (FIG. 2(b)). The in-plane method is excellent in that a uniform phase-contrast image can be obtained over a wide area. However, it is generally difficult to achieve alignment for permitting the zeroth-order light to pass through the small center hole. In contrast, the off-plane method offers only a narrow phase-contrast image portion but dispenses with alignment. In addition, a non-phase-contrast image, or an ordinary electron microscope image, can be taken simultaneously.

FIGS. 3(a), 3(a′) and 3(a″) show an electron microscope image of an amorphous carbon film taken by the off-plane method. The phase plate was the amorphous carbon film having a thickness of 24 nm and given a phase shift of 0.4 π. A genuine circle of 1 μm was formed as a center hole by a focused gallium ion beam-emitting machine. The roundness of the hole was checked with the focused ion beam microscope image of FIG. 3(b). The central, bright portion of FIG. 3(a) is a phase-contrast image portion, while the outer portion is a normal microscope image portion. By Fourier-transforming these portions, contrast transfer functions (CTFs) are obtained (see FIGS. 3(a′) and 3(a″)). As anticipated, the CTF inside the center hole showed an intensity CTF (cosine type). The CTF outside the center hole exhibited a phase CTF (sine type). Two small black circles can be observed in the center of the CTF of the outside of the center hole. These are images originating from the center hole. Information about this portion is lost, unlike a normal microscope image. In any case, it has been demonstrated that the off-plane method operates theoretically.

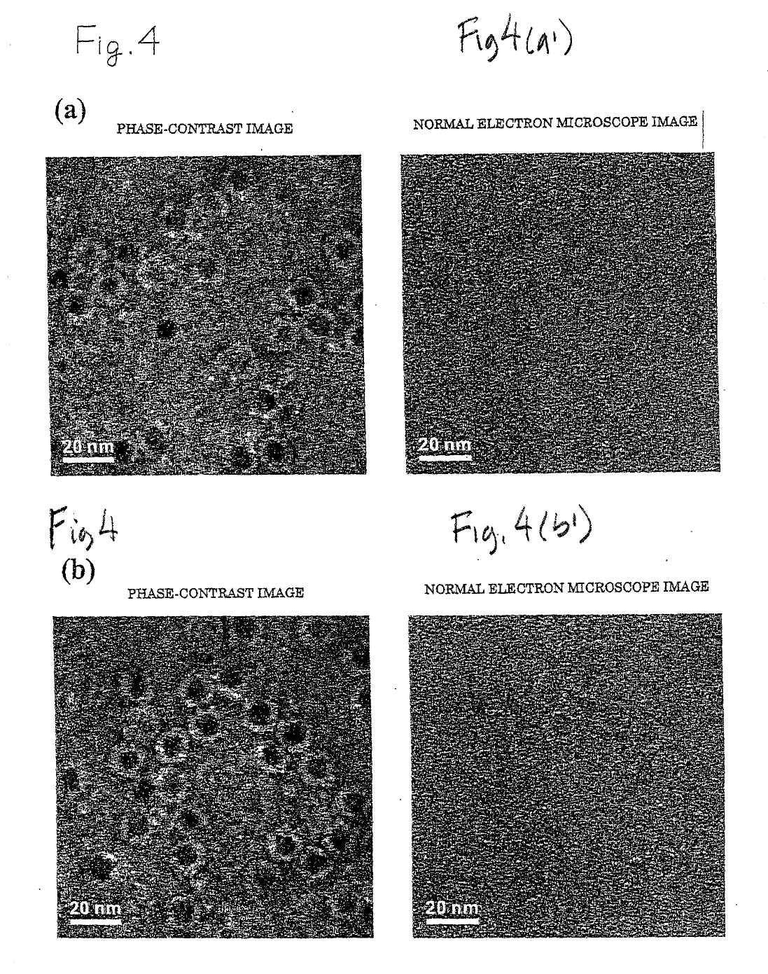

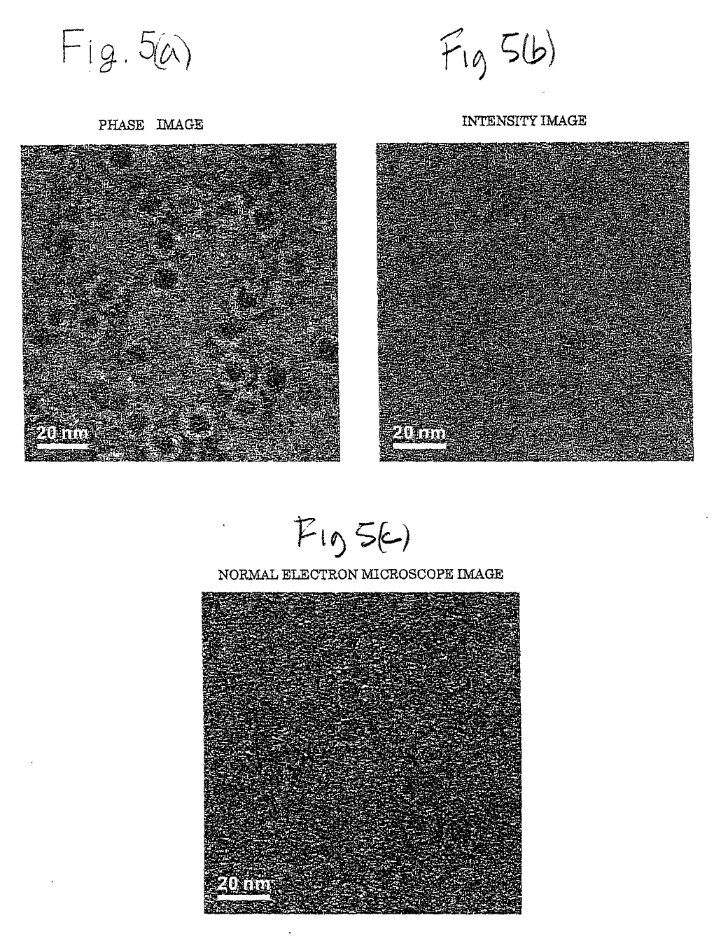

Examples of experiments on phase-contrast images are given below. FIGS. 4(a), 4(a′), 4(b) and 4(b′) show phase-contrast electron microscope images. FIGS. 4(a) and 4(a′) show a phase-contrast image of ferritin molecules negatively stained on a grid, as well as a normal electron microscope image. FIGS. 4(b) and 4(b′) show a phase-contrast image of a different portion of ferritin molecules on a grid, as well as a normal microscope image. FIGS. 5(a), 5(b) and 5(c) show complex electron microscope images. Phase-contrast images and normal electron microscope images as shown in FIGS. 4(a), 4(a′), 4(b) and 4(b′) are combined complexly to reproduce complex images. Thus, a stigmatic phase-contrast image of ferritin molecules, a stigmatic intensity image, and a normal electron microscope image are compared in FIGS. 5(a), 5(b) and 5(c).

An image of protein negatively stained with uranium using a phase plate having a center hole and an image of ferritin having a diameter of about 12 nm and a molecular weight of 450,000 and containing iron oxide having a diameter of 6 nm in its center were taken. The phase-contrast image and normal electron image were compared. A phase plate made of an amorphous carbon film having a thickness of 24 nm was used.

FIGS. 4(a) and 4(b) show a phase-contrast image of a portion of ferritin and FIGS. 4(a′) and 4(b′) show a normal electron microscope image of the same portion. The phase-contrast image was taken by the off-plane method after inserting a phase plate having a center hole into a microscope of 300 kV. The normal electron microscope image was taken by an ordinary method in which no phase plate was inserted. Two images of ferritin molecules on the same grid are shown. It can be seen that both phase-contrast images are shown at extremely high contrast. Since the photographs are taken from the same portion, the difference is made obvious by comparing the right and left photographs. Especially, the degree of blackness of the phase-contrast image has quantitativeness. Clearly, the iron oxide crystal portion in the center of the ferritin is blackest. The Uranium stain has been removed from the protein portion (negatively stained), and thus this portion is whitest. This reflects the fact that almost every substance has only phase variations as image information as mentioned previously. Hence, a phase-contrast microscope is a natural form of an electron microscope.

A phase-contrast image as shown in FIG. 4(a) and a normal electron microscope image as shown in FIG. 4(b′) are combined to create a complex image. The CTF of the lens can be removed. This method is known as complex observation method or as complex signal detection method (Kuniaki Nagayama, Japanese Patent application No. 361439/1997, “Complex Signal Detection Method, Complex Microscope, and Complex Diffraction Apparatus”), and is one application of the phase-contrast method. If this method is applied, the intensity and phase of a wave function can be separated and purely imaged. FIG. 5(a) shows a phase image (different from a phase-contrast image) obtained by a complex observation of ferritin molecules and an intensity image. A normal microscope image of the same location is also shown (FIG. 5(c)). The results demonstrate that an electron microscope image intrinsically has phase information alone. An intensity image has a contrast that is lower by a factor of 10 or more than that of a phase image. It can be said that intensity has little image information. A part of image information (such as shown in a phase image) contained in a normal electron microscope image is converted into an intensity image by the aforementioned Scherzer's method (using defocus). In this image, the contrast is low and the image is an intrinsically distorted image modulated by phase CTF.

The two experimental examples (phase-contrast microscope image and complex microscope image) prove that the phase plate built in accordance with the present invention and with a center hole operates correctly in accordance with the principle.

Furthermore, in the case of FIG. 1, the thin film forming the phase plate consists of an electric conductive amorphous carbon. Instead, an electric conductive amorphous gold or a composite of an electric conductive amorphous carbon and an electric conductive amorphous gold may be used as the thin film.

Now, a charging phenomenon of the phase plate is investigated. If the phase plate consists of an electric conductive material, the phase plate does not charge. A carbon film ordinarily has a relatively high resistance, however, if the electric conductivity of it is larger than 1 Ω-1 m-1, the carbon film does not charge.

It is thought that insulating carbon compounds which adhere to the surface of the phase plate cause charging. It is also thought that the carbon compounds are formed from various contaminants absorbed on the surface of the phase plate by chemical reactions caused by electron beam irradiation.

Moreover, the charging to the insulating carbon compound results from a dynamic balance between increase of electric charge due to inflow of electrons and decrease of electric charge due to leak to the conducting phase plate. Accordingly, it can be said that if electron dose per unit area is small, charging can be neglected.

In the back focal plane of the objective lens, the most intensive electrons are transmitted electrons that transmit the specimen. It is thought that charging of the phase plate can be avoided by focusing the transmitted electrons on the back focal plane completely and permitting the focused electrons to pass through the center hole of the phase plate. In this case, nearly 90% of transmitted electrons enter into a next lens system without passing through the phase plate. The remaining 10% of scattered electrons spread spatially and illuminate the phase plate. Therefore, if the electron does is small, the phase plate does not charge easily.

The above expectation was confirmed by an experiment of electron beam irradiation using an FEG (field emission gun) having a good focusing characteristic and capable of focusing a very small cross-over on the focal plane. In the experiment, the phase plate was placed on the back focal plane correctly and almost all transmitted electrons could pass through the center hold of the phase plate whose diameter was 1 μm. This experiment proved that charging of the phase plate could be decreased remarkably.

In the general case in which an electron beam is not irradiated in parallel, charging of the phase plate can be prevented by adjusting x, y and z position of the phase plate so that the cross-over of the transmitted electrons enter the center hole of the phase plate. In such case, it is very important to finely adjust the relative position of the phase plate to the transmitted electrons so that the transmitted electrons do not touch the phase plate. In general, such position adjustment of the phase plate can be done easily by enlarging the diameter of the center hold of the phase plate. However, in this case, it is disadvantageous for obtaining a high quality phase-contrast image because low frequency components of electron waves are not contained in the phase-contrast image and the contrast of the image is lost.

Accordingly, it should be essential for a phase-contrast electron microscope having a small center hole of the phase plate, to have a combination of an FEG which realizes an electron-beam irradiation with a small cross-over and a phase plate position fine adjusting mechanism which is capable of moving the phase plate in x, y, z directions.

Having thus described our invention with the detail and particularity required by the Patent Laws, what is desired protected by Letters Patent is set forth in the following claims.

What is claimed is:

1. A phase plate placed on a path of electrons having passed through an objective lens of an electron microscope, said phase plate consisting of a thin film of an electric conductive amorphous material or a thin film of a composite of electric conductive amorphous materials.

2. The phase plate of claim 1, wherein said thin film has a thickness controlled so as to delay phase of electron waves by π/2.

3. The phase plate of claim 2, wherein said thin film has a microscopic circular hole for permitting passage of an electron beam.

4. The phase plate of claim 3, wherein said circular hole for permitting passage of an electron beam is a genuine circle having a diameter of 0.05 μm to 5 μm.

5. The phase plate of claim 2, wherein a genuinely circular amorphous material is deposited on said thin film for delaying phase of electron waves by π.

6. The phase plate of claim 5, wherein said deposited, genuinely circular amorphous material has a diameter of 0.05 μm to 5 μm.

7. A phase-contrast electron microscope comprising:
a phase plate made of a thin film of an electric conductive amorphous material or a thin film of a composite of electric conductive amorphous materials, said phase plate being placed on a path of electrons having passed through an objective lens of an electron microscope.

8. The phase-contrast electron microscope of claim 7, wherein said phase plate made of the thin film has a genuinely circular hole for permitting passage of an electron beam, said hole having a diameter of 0.05 μm to 5 μm, said hole being located in the center of an electron beam path, and wherein said phase plate is located in the back focal plane of an objective lens or behind said back focal plane.

9. The phase-contrast electron microscope of claim 7, wherein an amorphous material having a diameter of 0.05 μm to 5 μm is deposited on said thin film for delaying phase of electron waves passed through a center of an electron path by π, and wherein said amorphous material is placed in the back focal plane of an objective lens or behind said back focal plane.

10. The phase-contrast electron microscope of claim 8 or 9, wherein said electron beam is emitted from a field emission gun and wherein there is further provided a phase-plate position fine adjusting apparatus for moving said phase plate.

11. A method of preventing charging of a phase plate placed on a path of electrons having passed through an objective lens of an electron microscope, said phase plate consisting of a thin film of an electric conductive amorphous material or a thin film of a composite of electric conductive amorphous materials, said method comprising the step of:
illuminating said phase plate with a large electron dose before use of the microscope.

12. The method of claim 11, further comprising the step of keeping said phase plate at a high temperature.
